(19) United States
(12) Patent Application Publication
(10) Pub. No.: US 2006/0015363 A1
(43) Pub. Date: Jan. 19, 2006

(54) Systems and methods for processing invoices based on a minimum invoice amount

(75) Inventors: David Allu, Wharton, NJ (US); Chris Cunningham, Monroe, NY (US); Tom Parshley, Timonium, MD (US); Paul Dittmar, Baltimore, MD (US); Mike Volpicella, Slate Hill, NY (US); Michael Walters, Bogota, NJ (US); Joe Wallwork, Flanders, NJ (US); Angela Banks, Alpharetta, GA (US); Cheryl Fisher, Burlington Twp, NJ (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc., Atlanta, GA (US)

(21) Appl. No.: 11/153,770

(22) Filed: Jun. 14, 2005

Related U.S. Application Data
(60) Provisional application No. 60/587,572, filed on Jul. 12, 2004.

(51) Int. Cl. G06Q 99/00

(52) U.S. Cl. 705/1

(57) ABSTRACT

Systems and methods are defined for processing an invoice indicating an amount due in which the processing of the invoice, which typically includes printing the invoice, is dependent in part on the amount due. Specifically, certain procedures may be invoked when the amount due is less than a threshold level, such as deferring generating an invoice until the next billing cycle. Various types of indicators facilitate exception processing of the invoice, including the ability to exempt the account from minimum invoice processing. The indicators are contained as parameters in the invoice records allowing flexibility in the computer system processing the records.

### CROSS REFERENCE TO RELATED APPLICATIONS

This application claims the benefit of U.S. provisional patent application No. 60/587,572, filed on Jul. 12, 2004.

### FIELD OF THE INVENTION

This invention pertains to processing invoices, including those associated with shipping invoices generated by a shipping provider. In particular, a method is defined for processing an invoice for an amount due associated with an account wherein if the amount due is below a certain threshold, the processing of the invoice may be deferred until the next billing cycle or otherwise processed in a specially defined manner.

### BACKGROUND OF THE INVENTION

It is well known that certain costs are associated with performing various business functions, even though those which are relatively routine. For example, a business entity processing accounts receivable information incurs various fixed costs and variable costs in order to prepare invoices for each account. These costs include allocating time for personnel and resources, including those associated with computing systems for processing accounts receivable information. Typically, these activities result in the generation of a paper-based invoice. In billing an account, the supplier periodically renders a bill for the current balance, and mails or otherwise transmits the invoice in some manner. The preparation of a bill entails computer processing, printing an invoice, mailing the invoice, recording the amount due for the billing cycle, receiving the payment, and then updating computer records and accounting information. Each operation in the process typically incorporates a fraction of a person's time, requires certain processing resources, or otherwise consumes certain supplies. For example, the paper and envelope has a fixed cost assigned, as does the postage. Thus, it is not surprising that for processing each invoice, a minimum cost can be attributed to its generation. Further, generating invoices also incurs associated costs for paper storage as well as accounting and collection related costs.

Thus, the entity generating the invoice may incur greater costs in generating the invoice and processing payment than the amount due on the invoice. If certain common business practices such as invoicing for small amounts, are found inefficient relative to revenue obtained by the practice, then one solution in the past has been to simply waive the amount due. However, this approach causes a direct loss of the amount due to the entity generating the invoice. Therefore, approaches to minimize costs and retain collection of revenue are needed.

### BRIEF SUMMARY OF THE INVENTION

The present invention augments methods of invoice processing used by computer systems to process various invoices for customers of shipping services (“accounts”) by selectively printing an invoice based in part on the value of the amount due indicated by the invoice. One embodiment defers generation of an invoice when the amount due is less than a threshold level until the next billing cycle. Optionally, processing of the invoice may take into account various other flags and conditions, which can be specific to a particular country, account, invoice amount, or other business practice rule as specified by the system in conjunction with processing the invoice and account information.

The present invention includes computing systems for selectively printing invoices based in part on the above mentioned conditions as well as computer readable media containing software for causing a computer to selective print invoices consistent with the above criteria.

This summary is not intended to limit the scope of any claims submitted herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 represents one embodiment of a computer system used to practice the principles of the present invention and storing the various data structures used therein,

FIG. 2 represents one embodiment of a system associated with the present invention,

FIG. 3 represents one embodiment of a table indicating invoice data used in processing invoices from various accounts,

FIG. 4 represents one embodiment of a flow chart implementing some of the steps in processing an invoice, and

FIG. 5 represents one embodiment of a flow chart implementing further steps in processing an invoice.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The systems and methods of the present invention are advantageous in the processing of invoices associated with account receivables. Although the disclosed embodiment is in the context of generating invoices for customers of shipping services, the principles of the present invention can be applied to a variety of business contexts and is not limited to shipping related services. In general, various parameters are indicated that are used to determine how to process an invoice amount that is below a certain threshold level in order to reduce expenses associated with invoice processing. This overall process is called threshold level invoice processing or minimum invoice level processing. If the invoice amount meets certain criteria, the generation of the invoice may be deferred, typically for a billing cycle. It is expected in many instances that the amount due for a given invoice will be added to a subsequent invoice, increasing the likelihood that the second invoice is greater than the threshold level. This algorithm lends itself to applications where repeated, periodic invoices are billed to an account. If there is no expectation of subsequent invoices being generated in the near future involving that account, deferral of the invoice is typically not performed. The present invention allows a rich set of options, allowing flexibility in application of exception conditions in processing invoices. Although certain options and variations are disclosed, it will be readily seen that various other combinations of exception procedures, default procedures, and overrides can be constructed to meet the business needs.

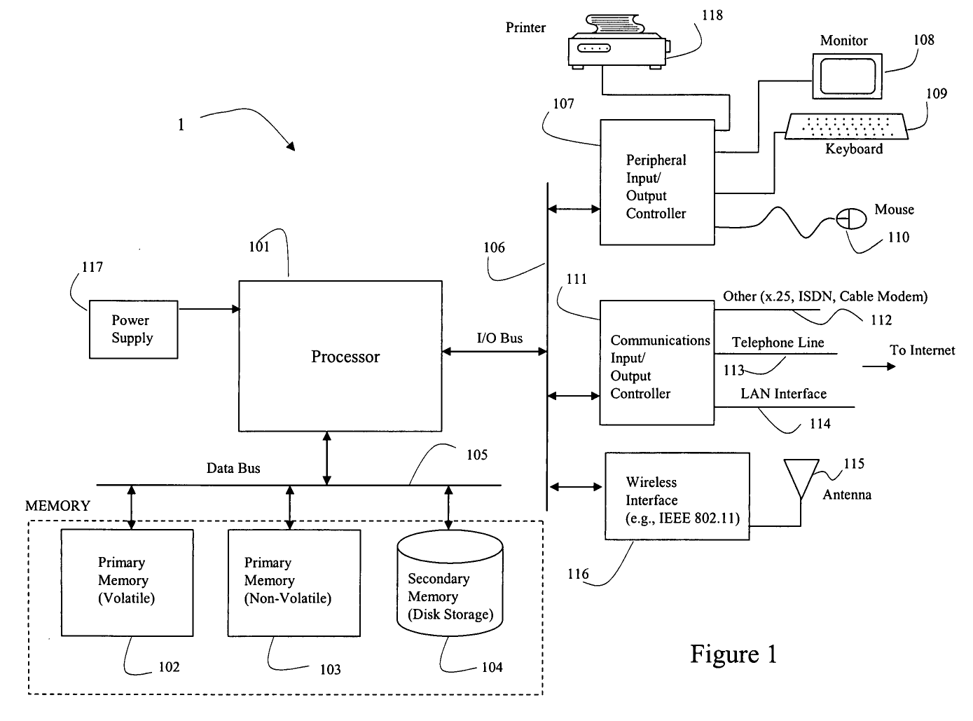

The invention is typically embodied as a software program executing on a computer functioning as a invoice processing system. The software typically involves processing accounts receivable on a periodic basis (e.g., a billing cycle typically comprising a month). In general, the use of computers in processing accounts receivable information and generating invoices for accounts on a periodic basis is well known in the data processing arts. A typical computer used for executing the program is illustrated in FIG. 1. Turning to FIG. 1, one embodiment of one such computer is illustrated for practicing aspects of the present invention. In FIG. 1, a processor 101, such as a microprocessor, is used to execute software instructions for carrying out the defined steps. The processor receives power from a power supply 117 that also provide power to the other components as necessary. The processor 101 communicates using a data bus 105 that is typically 16 or 32 bits wide (e.g., in parallel). The data bus 105 is used to convey data and program instructions, typically, between the processor and memory. In the present embodiment, memory can be considered primary memory 102 that is RAM or other forms which retain the contents only during operation, or it may be non-volatile 103, such as ROM, EPROM, EEPROM, FLASH, or other types of memory that retain the memory contents at all times. The memory could also be secondary memory 104, such as disk storage, that stores large amount of data. In some embodiments, the disk storage may communicate with the processor using an I/O bus 106 instead or a dedicated bus (not shown). The secondary memory may be a floppy disk, hard disk, compact disk, DVD, or any other type of mass storage type known to those skilled in the computer arts. One of ordinary skill will recognize that as data is transferred between two or more computing devices (in accordance with the above-described processing steps), the data is read from and written to one or more of these memory areas and the memory area is physically changed as a result of the process.

The processor 101 also communicates with various peripherals or external devices using an I/O bus 106. In the present embodiment, a peripheral I/O controller 107 is used to provide standard interfaces, such as RS-232, RS-422, DIN, USB, or other interfaces as appropriate to interface various input/output devices. Typical input/output devices include local printers 118 that may be used to print the invoices once it is determined that they are to be presented, a monitor 108, a keyboard 109, and a mouse 110 or other typical pointing devices (e.g., rollerball, trackpad, joystick, etc.). In the case of printing large numbers of invoices, large, high speed printers may be utilized that incorporate collating and mailer preparation to facilitate mailing of invoices. Further, remote services providing such invoice printing/mailing capabilities may be utilized, in which communication may be accomplished using one of the following I/O capabilities.

The processor 101 typically also communicates using a communications I/O controller 111 with external communication networks, and may use a variety of interfaces such as data communication oriented protocols 112 such as X.25, ISDN, DSL, cable modems, etc. The communications controller 111 may also incorporate a modem (not shown) for interfacing and communicating with a standard telephone line 113. Finally, the communications I/O controller may incorporate an Ethernet interface 114 for communicating over a LAN. Any of these interfaces may be used to access the Internet, intranets, LANs, or other data communication facilities. In other embodiments, the presentation of the invoice may occur via electronic communication, using one of the aforementioned interfaces, to communicate the invoice. This can use one of the several electronic data interchange (EDI) standards or other proprietary communication protocols for conveying financial related data.

Finally, the processor 101 may communicate with a wireless interface 116 that is operatively connected to an antenna 115 for communicating wirelessly with other devices, including high speed printers, using for example, one of the IEEE 802.11 protocols, 802.15.4 protocol, or a standard 3G wireless telecommunications protocol, such as CDMA2000 1× EV-DO, GPRS, W-CDMA, or other protocols.

The aforementioned computer system may execute a standard operating system, such as the Microsoft WINDOWS™ operating system, although other systems may be used, as well as database managers for managing the various data files. Furthermore, any of the readily available programming languages may be used to implement the programs.

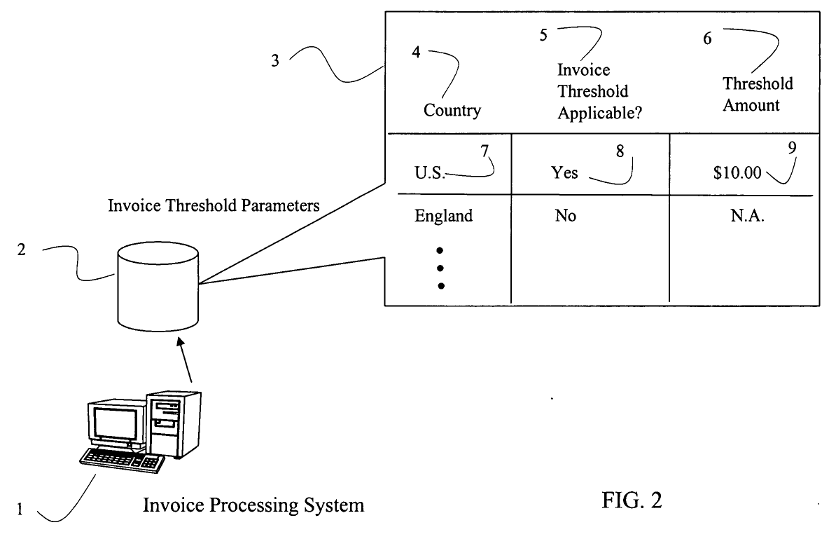

While the architecture of FIG. 1 illustrates one embodiment, other embodiments involving client-server, mainframe, batch processing, or other embodiments are readily applicable for practicing the principles of the present invention. The computing system 1 capable of processing the invoices is illustrated in FIG. 2 as a workstation computer.

Turning to FIG. 2, one billing parameter used in minimum invoice level processing is a threshold level. This is contained in a file referred to as the Invoice Threshold Parameter table (“threshold table”). The threshold table is typically stored in a database 2 maintained in the hard drive in the computer and retrieved using the aforementioned data bus for storage into the main memory where the processor can access the data for processing.

One embodiment of the aforementioned threshold table is shown as a tabular file 3. Recall that the system compares each invoice with a threshold level, and the level is stored in the threshold table. In this embodiment of the threshold table, parameters are indicated for various countries, as it is assumed the system processes invoices associated with accounts from various countries. Thus, column 4 of the table indicates each applicable country. It is expected that each country's statutes may differ, and the statutory or regulatory regimes may prohibit, limit, or otherwise impact the processing of invoices. Thus, a separate flag 5 is indicated as to whether each country allows such a scheme for deferring presentation of invoices based on a threshold amount, indicated in the last column 6. While presentation of invoices is discussed based mailing a paper-based invoice, other forms of presentation invoices are possible and are not excluded, including faxing, sending an electronic message, or other forms such as EDI.

In the example illustrated, the United States 7 is indicated as one of the countries that is associated with a threshold 8, the level 9 for which is indicated as $10.00. The threshold amount could be indicated in the currency of each country (or a pan-country currency, such as Eur\dot{o}s), or could be indicated as a percentage of the total bill. Further, a common currency (e.g., U.S. dollars) could be indicated and converted as necessary to determine the level for each country's currency.

While the threshold table 3 illustrates a table value when processing invoices that span various countries associated with accounts receivable, in many applications the system processes invoices for accounts located in a single country. In such instances, the threshold table may simply be stored as a variable, since no formal table scheme is required. Further, the concept of maintaining individual threshold amounts may be extended to a table that maintains threshold amounts for each account receivable. Thus, in other embodiments, the “country” 4 column may indicate an “account receivable.” Further, there may be separate “country” and “account receivable” values defined. A threshold defined on a “country” basis would apply to all accounts, but could be superseded by “account receivable” thresholds. Further, as it will be seen, exemptions could be defined for each account with respect to processing of the overall “country” applicable threshold. These exemptions can be defined for various reasons. For example, an individual account may be part of a consolidated billing account, in which a group of accounts are collectively billed. Thus, it would be undesirable to exempt one account from the group of accounts (further, it is unlikely the group of accounts would be less than then threshold). Other accounts may receive an electronically transmitted invoice, so that any cost saving benefits from not generating an invoice may be negligible.

These parameters are used in part by the invoice processing system 1 to determine whether the subsequently discussed procedures are applicable. It is further possible that additional parameters associated with each account or country may be stored and/or accessed by the Invoice Processing System. Such parameters are stored in the memory of the computer processing system and retrieved as necessary for processing.

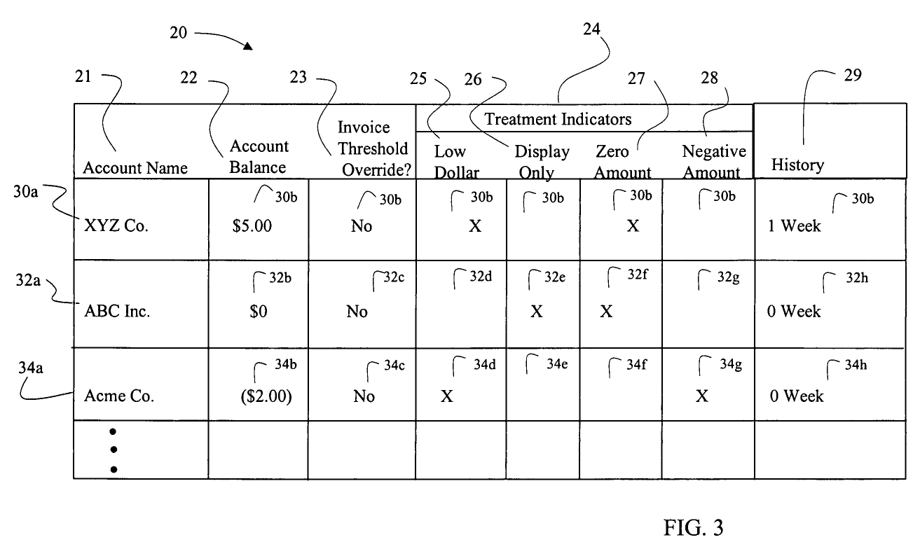

In addition, the system also typically maintains a table in which individual account receivable information is stored, as illustrated in FIG. 3. In FIG. 3, an account specific parameter table 20 contains information specific to an account that may be used in processing the invoice for a specific account. In many embodiments, additional fields may be added to provide information specific processing, while some fields may not be utilized. Further, as will be seen, the existence of certain values in some fields may impact the processing indicated by other fields.

In FIG. 2, the initial column 21 typically is an identifier of the account, which is illustrated here as the name of the account, although an account number may be used for ease of processing. Individual instances of account names are XYZ Co. 30a, ABC Inc., 32a, and Acme Co. 34a. The next column indicates the account balance 22, which for purposes of this illustration, is the same as the amount due on the invoice. Next, an override indicator 23 is provided that allows an individual account to be exempted from minimum invoice level processing. The indicator provides information as to whether an account has ‘opted out’ or has been excluded for other reasons. In other embodiments, a “flag” can be used. In still other embodiments, the default presumption is none of the accounts receive minimum invoice level processing treatment, and that the flag marks those which do receive it. Those skilled in the art of data processing will recognize that this indicator, which indicates whether minimum invoice level processing is allowable, can be implemented in various ways. The indicator can be associated with each account by storing the minimum invoice level processing in the same record, or the indicator can be linked and stored in a separate file.

The next column 24 indicates various “treatment indicators.” These additional indicators allow further specification of treatment for certain criteria, either based on the account or the amount associated with the invoice. These treatment indicators only apply if the minimum invoice level processing is applicable. These treatment indicators include low dollar amount 25, zero dollar amount 27, and negative dollar amount 28. The treatment indicators, of which there may be more or less than illustrated in FIG. 3, are based on the business rules for the current country and/or account, and define certain processing actions based on the invoice amount. In this case, the treatment indicators are embodied as “flags”, a well known construct used in computer science wherein a marker indicates one of two states or conditions. Thus, the presence of the flag indicates special treatment applies, whereas the absence of a flag indicates that no special treatment applies. Other constructs could be used equally as effectively, such as a binary indicator, or a logical value having two values (e.g., ‘true’ or ‘false’).

The low dollar amount 25 indicates that certain actions are to be taken when the invoice amount qualifies as a “low dollar” as indicated in the threshold. In this embodiment, for a company located in the U.S., the threshold has been defined as $0.01 up to and including $10.00. In other embodiments, a separate threshold value for each account can be defined indicating what is the low dollar amount threshold. This could be defined subject to a threshold applicable to the country or defined independent thereof.

The zero amount indicator 27 indicates whether the zero amount handling procedures apply if the invoice amount is zero.

Finally, a negative amount indicator 28 indicates procedures to be followed if the invoice amount reflects a negative amount due (e.g., a credit).

Another type of treatment indicator is the Display Only 26 indicator that indicates the account balance should be only displayed, and that no generating of an invoice should occur. Namely, the invoice may be presented (e.g., displayed) even if the account has the low dollar indicator set. The Display Only indicator can be used to display invoices for informational purposes only.

Each column indicates whether the procedures defined for each of these conditions is to be applied if the invoice meets the criteria. In some embodiments, a separate rules file may be linked to define the procedures for handling the specified condition. Thus, in various embodiments, the rules for handling a negative amount may be common for all entities in a country, whereas in another country or for another account, unique procedures may be defined for handling a negative amount. In one embodiment, all accounts in all countries receive the same treatment, and an account specific column need not be defined. In other embodiments, each account may have individual rules defined, or associated with a set of rules. Further variations are possible when considering the interaction of electronic invoices compared to paper invoices. For example, the invoice system may issue electronic invoices regardless of the amount (since the costs of mailing a paper invoice are not present) whereas the invoice system may defer sending an invoice if a paper based invoice is mailed. This specific variation is not indicated in FIG. 3, but those skilled in the art will readily appreciate that the principles of the current invention allow great flexibility in defining exception handling procedures for various accounts and circumstances. Thus, this scheme can be easily adapted to allow the definition and implementation of new rules and procedures regarding how invoices should be processed.

Finally, a history column 29 indicates a counter, flag, or other type of indicator associated with previous deferral of the invoice that occurred in conjunction with minimal invoice processing. Typically, a counter or indicator indicating an immediately previous deferral is present. Although the present illustration does not record the condition previously encountered, e.g., triggering the deferral, some embodiments may implement a counter for each condition that triggered deferral of the invoice. Alternative embodiments may maintain a tabular history based on each invoice for an account and the reason, if any, of the deferment whereas other embodiments may use a simple flag. Of course, various types of structures and database mechanisms can be used to implement such capabilities.

The application of the above fields can be better explained by way of review of the specific examples provided in FIG. 3.

In FIG. 3, there are three records shown, although in practice there may be hundreds of records corresponding to hundreds of accounts as maintained in the memory of the computing system. Typically most records reflecting the current amount due will not have an invoice with an amount below the threshold. However, in this illustration, three companies with an invoice amount below the threshold are shown so as to illustrate various combinations that can occur in processing the invoice.

The first record is associated with XYZ Co. 30a as reflected in the name of the account. The invoice, or account balance 30b, is $5.00. In this embodiment, the invoice threshold (as defined in FIG. 2 and previously discussed) is $10.00. As explained previously, this may be a system wide parameter for all accounts, for an account associated with a specific country, or for a specific account. In this embodiment, it is presumed that all accounts are subject to a $10.00 minimum threshold amount. Since the invoice (e.g., account balance) is less than the threshold indicated of $10.00, the invoice deferral procedures are triggered. In this example, an indication 30d in the low dollar column 25 indicates that the threshold level invoice procedures apply to this account. If the account were to be exempted for whatever reason, then no indication or flag would be provided and the invoice would be generated. Further, in the case of the XYZ Co. account, the “zero amount” procedures apply. Thus, an invoice should be deferred if the amount due is either $0 (zero value) or $0.01 to $10.00 (low dollar amount). Finally, the history counter 30h indicates that this account has had its invoice deferred in the billing cycle immediately preceding the current billing cycle. In this embodiment, the cycle is illustrated as being one week, although other periods or units can be indicated. In other embodiments, billing may be based on a monthly period. The system logic may be programmed to allow a maximum number of deferrals, after which invoices will be generated even if the amount is less than the threshold.

In contrast, the next record in the database, which is associated with the ABC Co. 32a has an account balance of $0 and it is eligible for the “display only” 32e and the zero amount 32f procedures. In this case, because the invoice amount is $0 and the zero amount indicator is set, the “zero amount” procedures apply, thus causing the invoice to be generated for informational purposes. This system has not previously deferred an invoice, as the history counter indicates a zero amount.

Finally, the next illustrative account, the Acme Co. 34a has a credit (negative account balance) 34c of ($2.00) and it is eligible for the low dollar and negative amount procedures. The “low dollar” procedures may be overridden by the “negative amount” (credit) procedures. In general, the procedures for handling specific treatment for one type of condition may be modified by other procedures given a higher priority. For example, the general treatment for a low dollar indicator may be to defer mailing of the paper invoice. However, if the invoice represents a credit (e.g., negative amount), then the handling of the invoice instead may be defined by the “negative amount” procedures. Thus, the invoice system may defer sending low invoices to an account, but if there is a credit due, the system may instead always send the invoice reflecting the credit. While this could be defined as a default procedure incorporated into the low dollar procedure, the above embodies this capability as a separate “negative amount” exception procedure. Regardless of how it is implemented, it is possible to handle some customers with a negative amount differently by sending one account a paper invoice, whereas other accounts having a negative amount defer sending of the invoice. Further exception handling procedures could be defined by defining a low amount negative treatment and a high amount negative treatment indicator. Thus, accounts receiving a low amount of credit (e.g., $2.00) do not receive a paper invoice, whereas those with a higher credit amount (e.g., $20.00) would receive a paper invoice or result in a check being issued.

In each case, the history counter is used to establish a cap or limit as to the number of times an invoice for a particular account may be consecutively deferred or deferred within a time period. Thus, if an account previously had a low value resulting in deferral of mailing a paper invoice, a subsequent invoice, also of a low dollar value, may result in the invoice being generated. Otherwise, the low dollar amount would never be billed (or a credit may be forever carried forward). Thus, a limit as to how many times an invoice can be deferred can be built into the invoice process procedure by using the history counter 30h to ensure that deferred invoices are not “lost” due to repeated deferral.

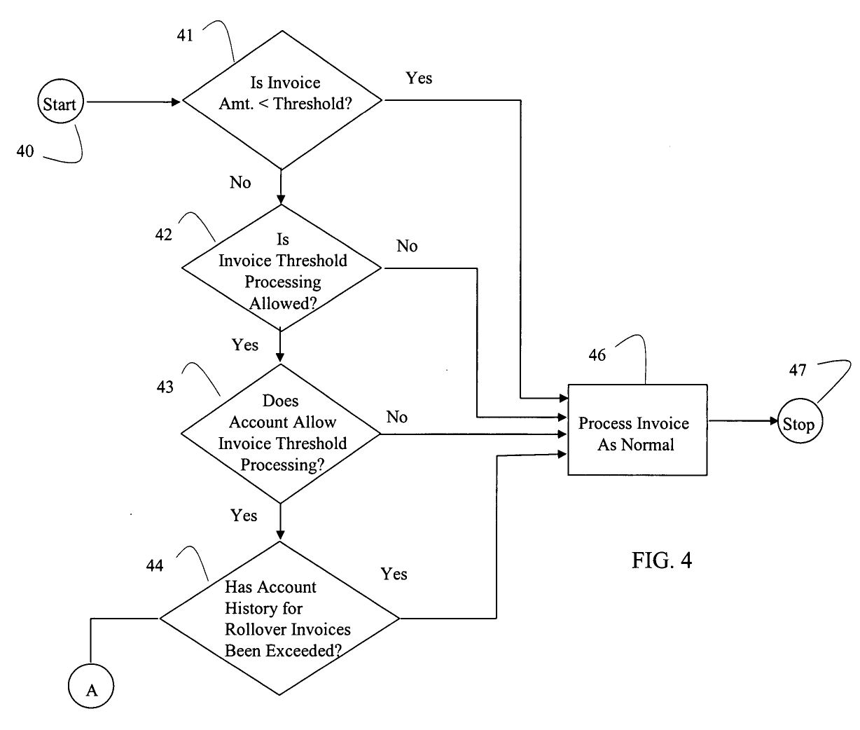

The above examples indicate how several records incorporating various flags and/or indicators can be used to process individual records. An overview of one algorithm that can be defined is illustrated by a flowchart in FIG. 4, although variations exist and are within the scope of the present invention. In FIG. 4, the process begins at step 40 by the invoice system accessing the database and retrieving an invoice record for an account, and determining 41 whether the amount due is less than the threshold. If the amount due is greater than the threshold defined for that entity (which may be a country-wide value or account specific, as previously discussed), then the invoice should be processed as normal 46, at which time the process completes 47.

If the threshold in step 41 has not been met, then the next step 42 is to determine whether the invoice threshold processing is allowed. Recall that there are at least two ways in which a particular invoice may not be eligible. First, all invoices associated with a particular country may not be eligible, or that particular account may be flagged 43 as not allowing such processing. In either case, if threshold invoice processing is not allowed, the process completes 46 as normal and stops 47.

If threshold level processing is allowed, then the history counter limit is checked 44 to determine whether previous deferral or ‘rollovers’ have been exceeded for this account. If so, then the processing of the invoice 46 completes as normal and the process stops 47.

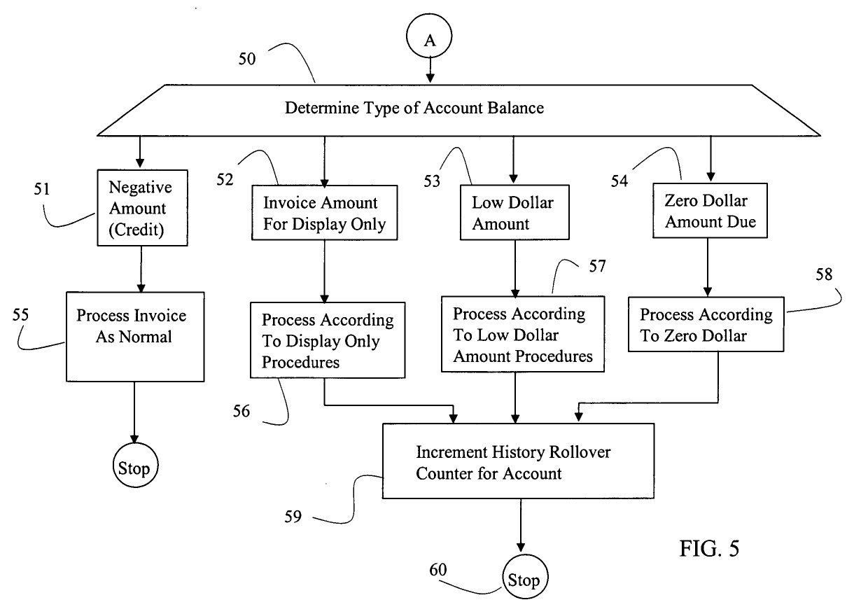

If all conditions are met, as shown in FIG. 4, then the processing shown in FIG. 5 may proceed. Turning to FIG. 5, the first step 50 is to determine which treatment applies to the account balance. There are four categories defined, although others, or variations on these, may be defined in addition, or in replacement thereof.

The first type of account balance is a negative amount 51. In this embodiment, negative invoice amounts are defined as being processed as normal invoices 55, resulting in a paper invoice being generated, at which time the process completes 60. In other embodiments, different treatments for individual accounts could be defined.

The next type of account balance is shown in step 52 as an amount associated for display purposes only. In this type, the account balance is presented using an invoice for information purposes only. For example, the account may be a “freight collect” transaction in which the amount due is not collected from the recipient of the invoice but notice of the amount due is conveyed using the invoice. In such instances, even if the amount invoiced is less than the threshold, an invoice may be sent to the consignee (more as a notice function than as an invoice to the account payable entity). Thus, the invoice is processed according to the Display Only Procedures 56 in which the invoice may be generated as normal.

Next, a low dollar amount 53 invoice may exist, in which the invoice is determined to be deferred, at least until the next billing cycle as defined by the relevant procedures 57. In this case, the lower dollar amount procedures 57 reflect the processing associated with the display only procedures 56 and negative amount procedures 56 as well as others if appropriate. These procedures may also take into account the number of times the invoice has been previously deferred. As indicated, the procedures can be easily customized to accommodate the desired business rules.

Finally, the last type of account balance may be a zero dollar amount, in which the invoice generator may be deferred only if the invoice reflects a zero total. This typically occurs if an account, which is paid up, does not generate any billing related activities, so that the next bill amount is zero. These procedures 58 may suppress an invoice or defer transmittal of the invoice, similar to the low dollar amount procedures 57. However, the embodiment illustrated in FIG. 5 allows the zero dollar procedures and the lower dollar amount procedures 57 to be different.

Regardless of the type of account balance, the system generally records a history of the invoice treatment, at least so as to increment the counter 30h, or otherwise record the treatment in some manner. This allows notation of previous treatment of an invoice when subsequently processing another invoice from that account. Thus, invoices may be deferred a limited number of times, resulting in an invoice being generated regardless of other indicators. Although not illustrated in the Figures, the normal processing of an invoice is modified so that when an invoice is generated, this treatment is recorded as well. Thus, if a simple flag or counter is used to indicate deferral of an invoice, the flag or counter is reset upon generating an invoice.

Although the following invention has been illustrated using invoices, the same principles could apply to other types of commercial transactions, such as credit indications, material returns, or other documents in which the cost of processing may exceed the value associated with generating the document or communication.

Further, it is evident that a variety of indicators, treatments, and other specific procedures and overrides can be defined to allow efficient and customizable treatment of invoice amounts below a certain threshold. Further, it is evident that there are various other data structures and formats that could be used to indicate such data for embodying the present invention.

That which is claimed:

1. A system for selectively printing invoices comprising:
a database storing an invoice threshold amount and a plurality of records wherein each record is associated with an account identifier, a balance due, and an indicator used to determine whether minimum invoice level processing is allowed in conjunction with the record;
a printer for printing a paper-based invoice; and
a processor programmed to retrieve from the database an invoice record from the plurality of records, the processor determining that the indicator does not allow minimum invoice level processing in conjunction with the record, the processor generating and printing the paper-based invoice associated with the record.

2. A system for selectively printing invoices comprising:
a database storing an invoice threshold amount and a plurality of invoice records wherein each invoice record is associated with an account identifier, a balance due, and a minimum invoice level processing allowed indicator;
a printer for printing a paper-based invoice; and
a processor programmed to retrieve from the database an invoice record from the plurality of invoice records, the processor further programmed to determine that minimum invoice level processing is allowed thereby selectively allowing suppression of the generation of an invoice, the processor further programmed to determine that the balance due is less than the invoice threshold amount, and record an indication of invoice suppression in the invoice record.

3. The system of claim 2 wherein the processor is programmed to process the invoice record so as to issue a refund if the amount due is a negative amount.

4. The system of claim 2 wherein the processor is further programmed to print the invoice if the amount due is greater than the threshold amount, and the minimum invoice level processing allowed indicator prohibits invocation of minimum invoice level processing.

5. The system of claim 2 wherein the processor records an indication in the invoice record when the processing of the invoice record does not result in printing the paper-based invoice.

6. The system of claim 2 wherein the processor is programmed to print the invoice if the minimum invoice level processing allowed indicator prohibits minimum invoice level processing.

7. A method of processing invoices resulting in selective printing of an invoice, the method comprising:
retrieving a record from a database wherein the record comprises an account receivable identifier and an amount due;
determining that the amount due is less than a threshold level;
determining that a minimum invoice level processing indicator allows minimum invoice level processing whereby printing of an invoice is suppressed;
invoking the minimum invoice level processing thereby suppressing printing of the invoice; and
incrementing a counter associated with suppression of the invoice wherein the counter is stored in the record.

8. A method of claim 7 further comprising the step of:
determining that the counter associated with suppression of the invoice is less than a second threshold level.

9. The method of claim 7 further wherein generation of the invoice comprises:
printing a paper-based invoice.

10. The method of claim 7 further comprising the step of:
determining that the amount due is a negative amount and less than a second threshold amount.

11. A method for processing invoices resulting in selective printing of an invoice associated with an account identifier comprising the steps of:
retrieving a record from a database wherein the record comprises the account identifier, an amount due, and an indication of previous deferral of invoice generation associated with the account identifier;
determining that the amount due is less than a threshold associated with minimum invoice level processing;
determining that minimum invoice level processing is not allowed for processing the invoice associated with the account identifier; and
printing the invoice indicating the account identifier and the amount due.

12. The method of claim 11 wherein determining that minimum invoice level processing is not allowed is based on an indicator associated with the record.

13. The method of claim of claim 11 wherein determining that the minimum invoice level processing is not allowed is based on determining a counter indicating previous deferral of invoice generation exceeds a second threshold.

14. The method of claim of claim 11 wherein determining that the minimum invoice level processing is not allowed is based on the amount due being a negative amount.

15. A computer-readable storage medium containing a set of computer-executable instructions for a method of selectively printing an invoice, said set of instructions comprising:
retrieving information from a first file identifying an account and an amount due associated with the account;
determining that minimum invoice level processing is allowed for the account;
retrieving information indicating an invoice threshold amount;
determining that the amount due is greater than the invoice threshold amount thereby not triggering execution of a minimum invoice level processing routine; and
printing an invoice identifying the account and the amount due.

16. The computer-readable storage medium of claim 15 further comprising instructions for:
recording an indication in the first file associated with the account indicating the printing of an invoice.

17. The computer-readable storage medium of claim 15 wherein the determining that minimum invoice level processing is not allowed for the account is based on processing an indication associated with the account indicating that minimum invoice level processing is not allowed.

18. The computer-readable storage medium of claim 15 wherein the determining that minimum invoice level processing is not allowed for the account is based on processing an indication associated with the account indicating previous deferral of invoice generation.

19. A computer-readable storage medium containing a set of computer-executable instructions for a method of selectively printing a paper-based invoice associated with an account, said set of instructions comprising:
retrieving first information from a first file comprising a plurality of invoice records wherein one of the invoice records is associated with the account and the invoice record comprises an account identifier and a first amount due;
determining that minimum invoice level processing is allowed for the account;
retrieving an invoice threshold amount;
determining that the first amount due is less than the invoice threshold amount;
invoking a minimum invoice level processing routine thereby suppressing generation of the paper-based invoice associated with the account; and
recording an indication in the invoice record of the suppression of the paper-based invoice.

20. The computer-readable storage medium of claim 19 further comprising the steps of:
retrieving a second record from the first file identifying a second account, the second record comprising a second account identifier and second amount due;
determining the second amount due is greater than the threshold amount; and
printing a second paper-based invoice associated with the second account.

21. The computer-readable storage medium of claim 18 further wherein the step of suppressing generation of the paper-based invoice associated with the account suppresses printing of the paper-based invoice associated with the account.
